(19) United States
(12) Patent Application Publication
(10) Pub. No.: US 2026/0335946 A1
(43) Pub. Date: Oct. 29, 2026

(54) METHOD FOR CLEANING ADHESIVE FROM SUBSTRATE AND SYSTEM OF PERFORMING THE SAME

(71) Applicant: BKS TEC CORP., HSINCHU CITY (TW)

(72) Inventors: Yang-Shih HSU, HSINCHU CITY (TW); Hsin Tse TSAI, HSINCHU CITY (TW)

(21) Appl. No.: 19/192,848

(22) Filed: Apr. 29, 2025

(51) Int. Cl. B08B 7/00; B08B 3/08; B08B 5/04

(52) U.S. Cl. CPC B08B 7/0042; B08B 3/08; B08B 5/04; B08B 7/0092; B08B 2220/01; B08B 2240/02

(57) ABSTRACT

A method for cleaning an adhesive from a substrate is provided, in which a fiber is cured in a v-groove of the substrate by the adhesive. The method includes: radiating the adhesive by an incident laser, so as to generate a heat to cause the adhesive to soften; and removing the fiber from the v-groove of the substrate. After the fiber is removed, the v-groove and the substrate is free from having the adhesive.

### TECHNICAL FIELD

The present disclosure is related to a method for cleaning adhesive from a substrate and a system of performing the same, and, in particular, to a method using a laser to cleaning adhesive from a substrate and a system of performing the same.

### DISCUSSION OF THE BACKGROUND

In the field of fiber-optic communications, connection accuracy and stability between the fiber connector and the optical fiber are essential for efficient transmission of the optical signal. Typically, the optical fiber or the fiber array unit is fixated on a substrate by a curing process. However, when the alignment of these optical elements is not optimal, these optical elements (including the substrate, fibers, fiber array unit, etc.) cannot be disassembled through reverse engineering. In other words, after the curing process is completed, the entire device must be discarded when the alignment of these optical elements is not optimal, and the overall cost of the devices is increased.

As demand for channels and bandwidth increases, optical devices having more fibers or fiber array units are being developed. Consequently, the chance of alignment being suboptimal increases. Therefore, how to effectively utilize defective products and reduce costs has become a critical issue in this field.

### SUMMARY

One aspect of the present disclosure provides a method for cleaning an adhesive from a substrate, in which a fiber is cured in a v-groove of the substrate by the adhesive. The method includes: radiating the adhesive by an incident laser, so as to generate a heat to cause the adhesive to soften; and removing the fiber from the v-groove of the substrate. After the fiber is removed, the v-groove and the substrate is free from having the adhesive.

In some embodiments, the method further includes determining whether an alignment of the fiber is in compliance with a requirement. When the alignment of the fiber is not in compliance with the requirement, the operation of radiating the adhesive is performed. When the alignment of the fiber is in compliance with the requirement, the method further comprises determining whether an alignment of a next fiber is in compliance with the requirement.

In some embodiments, the method further includes: after the fiber is removed, determined whether a residual of the adhesive exists on the substrate; and when the residual of the adhesive exists on the substrate, performing a first additional cleaning step to remove the residual of the adhesive. The operation of performing the first additional cleaning step to remove the residual of the adhesive includes: spraying a low-temperature material onto the substrate to lower a temperature of the residual of the adhesive, so as to weaken a bond between the residual of the adhesive and the substrate, wherein the operation of spraying the low-temperature material is performed in a chamber; and extracting, by vacuuming, the low-temperature material with the residual of the adhesive from the chamber.

In some embodiments, the method further includes: when the residual of the adhesive exists on the substrate, performing a second additional cleaning step to remove the residual of the adhesive. The operation of performing the second additional cleaning step to remove the residual of the adhesive includes: providing a volatile liquid onto the substrate to each the residual of the adhesive, so as to weaken the bond between the residual of the adhesive and the substrate, wherein the operation of providing the volatile liquid is performed in the chamber; and extracting, by vacuuming, the volatile liquid with the residual of the adhesive from the chamber.

In some embodiments, the volatile liquid is mixed with a carrier gas and provided by injecting. The carrier gas includes nitrogen, and the volatile liquid includes isopropanol or ethanol.

In some embodiments, the volatile liquid is provided by spraying. The volatile liquid includes isopropanol or ethanol.

In some embodiments, the low-temperature material includes liquid nitrogen, liquid carbon dioxide, or solid carbon dioxide.

In some embodiments, the operation of radiating the adhesive by an incident laser includes: controlling a beam size of the incident laser projected on the substrate; and scanning the substrate by the incident laser. A diameter of the beam size is about 60 μm, a central wavelength of the incident laser is about 1064 nm or 355 nm, and a power of the incident laser is between about 8 W and about 9 W.

In some embodiments, the operation of radiating the adhesive by the incident laser causes that a temperature of the adhesive is raised by the heat to above a glass transition temperature of the adhesive.

Another aspect of the present disclosure provides a method for cleaning an adhesive from a substrate, in which an optical device is cured by the adhesive on the substrate. The method includes: radiating the adhesive by an incident laser, so as to generate a heat to cause the adhesive to soften, wherein a temperature of the adhesive is raised by the heat to above a glass transition temperature of the adhesive; and removing the optical device from the substrate. The adhesive is disposed between a top surface of the substrate and a bottom surface of the optical device. After the optical device is removed, the substrate is free from having the adhesive. The substrate is a substrate of a co-packaged optics (CPO).

In some embodiments, the method further includes: after the optical device is removed, determined whether a residual of the adhesive exists on the top surface of the substrate; and when the residual of the adhesive exists on the top surface of the substrate, performing a first additional cleaning step to remove the residual of the adhesive. The operation of performing the first additional cleaning step to remove the residual of the adhesive includes: spraying a low-temperature material onto the top surface of the substrate to lower a temperature of the residual of the adhesive, so as to weaken a bond between the residual of the adhesive and the top surface of the substrate, wherein the operation of spraying the low-temperature material is performed in a chamber; and extracting, by vacuuming, the low-temperature material with the residual of the adhesive from the chamber.

In some embodiments, the method further includes: when the residual of the adhesive exists on the top surface of the substrate, performing a second additional cleaning step to remove the residual of the adhesive. The operation of performing the second additional cleaning step to remove the residual of the adhesive includes: providing a volatile liquid onto the top surface of the substrate to each the residual of the adhesive, so as to weaken the bond between the residual of the adhesive and the substrate, wherein the operation of providing the volatile liquid is performed in the chamber; and extracting, by vacuuming, the volatile liquid with the residual of the adhesive from the chamber.

In some embodiments, the operation of performing the second additional cleaning step is performed after the operation of performing the first additional cleaning step.

In some embodiments, the operation of performing the first additional cleaning step is performed after the operation of performing the second additional cleaning step.

In some embodiments, a central wavelength of the incident laser is about 1064 nm or 355 nm, and a power of the incident laser is between about 8 W and about 9 W.

In some embodiments, the operation of radiating the adhesive by an incident laser includes: controlling a beam size of the incident laser projected on the top surface of the substrate; and scanning the top surface of the substrate by the incident laser.

In some embodiments, a diameter of the beam size is about 60 μm.

Yet another aspect of the present disclosure provides a system of cleaning an adhesive from a substrate, in which an optical device is cured by the adhesive on the substrate. The system includes an illuminator and a mechanical arm. The illuminator is configured to generate an incident laser toward the adhesive, and raise a temperature of the adhesive accordingly. After the temperature is raised, by the incident laser, to above a glass transition temperature of the adhesive, the mechanical arm is configured to remove the optical device from the substrate.

In some embodiments, the system further includes a sprayer and a vacuum pump. The sprayer is configured to spray a low-temperature material onto the substrate to lower a temperature of a residual of the adhesive, so as to weaken a bond between the residual of the adhesive and the substrate. The vacuum pump is configured to extract the low-temperature material with the residual of the adhesive.

In some embodiments, the system further includes a dispenser and a vacuum pump. The dispenser is configured to provide a volatile liquid onto the substrate to each the residual of the adhesive, so as to weaken a bond between the residual of the adhesive and the substrate. The vacuum pump is configured to extract the volatile liquid with the residual of the adhesive.

In the present disclosure, the method for cleaning the adhesive and the system of performing the same are configured to remove the adhesive from a substrate, allowing the substrate to be reused and reducing costs.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiments disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of a co-package optics (CPO) from a top view perspective according to some embodiments of the present disclosure.

FIG. 2 is a schematic diagram of a CPO from a side view perspective according to some embodiments of the present disclosure.

FIG. 3 is a schematic diagram of a fiber array unit according to some embodiments of the present disclosure.

FIG. 4 is a schematic diagram of a CPO from a top view perspective according to some embodiments of the present disclosure.

FIG. 5 is a flow chart of a method for cleaning an adhesive from a substrate according to some embodiments of the present disclosure.

FIG. 6 is a schematic diagram of performing a portion of operations of the method shown in FIG. 5 according to some embodiments of the present disclosure.

FIG. 7 is a schematic diagram of performing a portion of operations of the method shown in FIG. 5 according to some embodiments of the present disclosure.

FIG. 8 is schematic diagram of performing a portion of operations of the method shown in FIG. 5 according to some embodiments of the present disclosure.

FIG. 9 is schematic diagram of performing a portion of operations of the method shown in FIG. 5 according to some embodiments of the present disclosure.

FIG. 10 is schematic diagram of performing a portion of operations of the method shown in FIG. 5 according to some embodiments of the present disclosure.

FIG. 11 is a schematic diagram of a system according to some embodiments of the present disclosure.

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

A photonic integrated circuit (PIC) uses a light source (e.g., a laser) to input light that drives the components, similar to turning on a switch to inject electricity that drives electronic components. In a PIC, photons pass through optical components such as waveguides, lasers, polarizers, and phase shifters. An electrical integrated circuit (EIC) is an assembly of electronic components in which hundreds to millions of transistors, resistors, and capacitors are interconnected and built up on a semiconductor substrate. When EIC and PIC are integrated using, for example, silicon photonics technology, at least one built-in optoelectronic (E/O) module which converts an electrical signal to an optical signal, and vice versa, may present for subsequent data processing.

Co-Packaged Optics (CPO) is an advanced heterogeneous integration of PICs and EICs on a single packaged substrate aimed at addressing next generation bandwidth and power challenges. CPO brings together a wide range of expertise in fiber optics, digital signal processing (DSP), switch application-specific integrated circuits (ASICs), and state-of-the-art packaging and test to provide a system-level value for the data center and cloud infrastructure.

The present disclosure provides a method for cleaning an adhesive on the substrate (such as a substrate of CPO) and a system configured to perform the method, so as to allow the substrate to be reused and reduce the cost of optical devices accordingly.

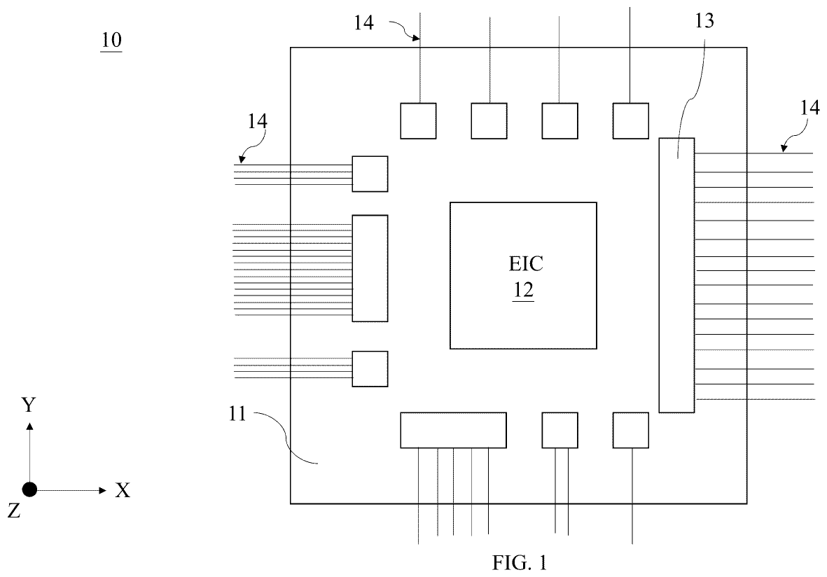

FIG. 1 is a schematic diagram of a CPO 10 from a top view perspective according to some embodiments of the present disclosure. The CPO 10 includes a substrate 11, an EIC 12, a plurality of optical components 13, and a plurality of fibers 14. The EIC 12 and the optical components 13 are disposed on the substrate 11, and the EIC 12 is surrounded by the optical components 13. Each of the fibers 14 is disposed on the substrate 11 and optically coupled to one of the optical components 13. The fibers 14 are configured to transmit optical signal from and to the optical components 13. The optical components 13 are electrically connected to the EIC 12 at least via the conductive wiring structure of the substrate 11.

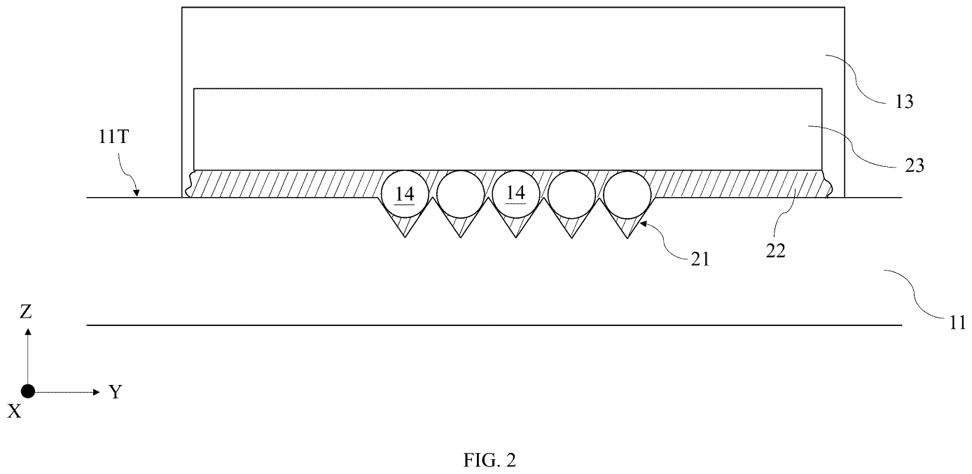

In some embodiments, the substrate 11 is a semiconductor substrate, such as silicon substrate. In some embodiments, the substrate 11 is a silicon on insulator (SOI) substrate. In some embodiments, the substrate 11 is a polymer substrate. In some embodiments, the substrate 11 includes v-grooves 21 (shown in FIG. 2) for accommodating the fibers 14. In some embodiments, the substrate 11 includes waveguide (not shown) for optically coupling the fibers 14.

In some embodiments, the fibers 14 are multi-mode optical fibers (MMFs) used for short-distance communication. In some embodiments, the fibers 14 are single-mode optical fibers (SMFs) used for long-distance communication.

It should be noted that the quantities of the optical components 13 and the fibers 14 are merely for illustrative purposes, various different quantities of the optical components 13 and the fibers 14 are with the contemplated scope of the present disclosure. Additionally, the quantity of the fibers 14 coupled to one optical component 13 is also merely illustrative.

FIG. 2 is a schematic diagram of the CPO 10 from a side view perspective according to some embodiments of the present disclosure. From the side view perspective (looking towards the plane mutually defined by the Y-axis and the Z-axis along the X-axis), the fibers 14 are respectively disposed on the v-grooves 21 and cured by an adhesive 22. A glass cap 23 is disposed over the fibers 14 and the adhesive 22, and configured to protect the fibers 14 and to help secure the fibers 14 in the V-grooves 21.

In some embodiments, the adhesive 22 includes a solid and dry polymer material which cured by a curing process. The curing process may include ultraviolet (UV) curing, thermal curing, or the combination thereof. In some embodiments, the fibers 14 are disposed in the v-grooves 21; then the adhesive 22 is filled into the remaining space in the V-grooves 21 and disposed on a top surface 11T of the substrate 11; after that, the glass cap 23 is disposed over and in contact with the fibers 14 and the adhesive 22. The adhesive 22 is then cured, by the curing process, to adhere the fibers 14, the substrate 11, and the glass cap 23 together.

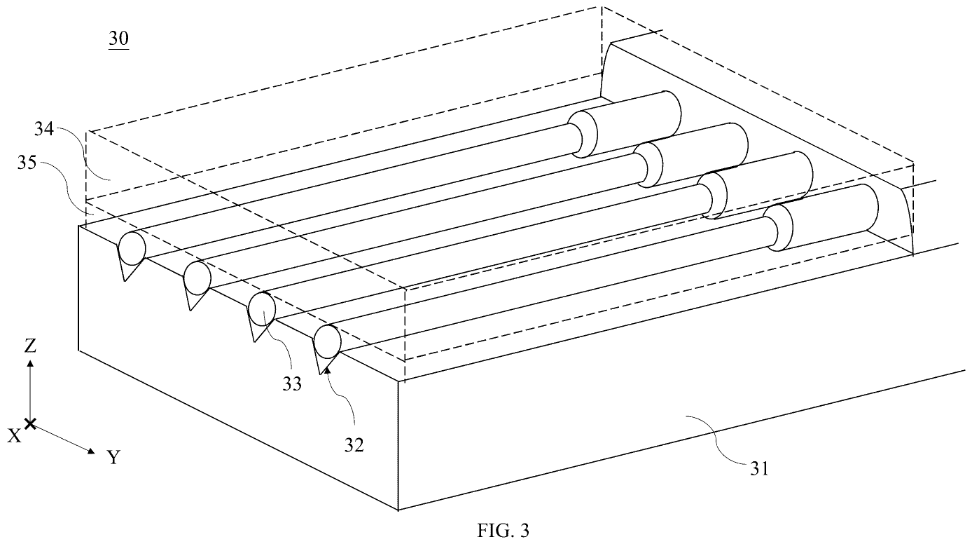

FIG. 3 is a schematic diagram of a fiber array unit 30 according to some embodiments of the present disclosure. The fiber array unit 30 includes a substrate 31, a plurality of fibers 33 disposed over v-grooves 32 of the substrate 31, a glass cap 34 over the fibers 33, and adhesive 35.

In some embodiments, the adhesive 35 is similar to the adhesive 22. The adhesive 35 is cured, by a curing process, to adhere the fibers 33, the substrate 31, and the glass cap 34 together.

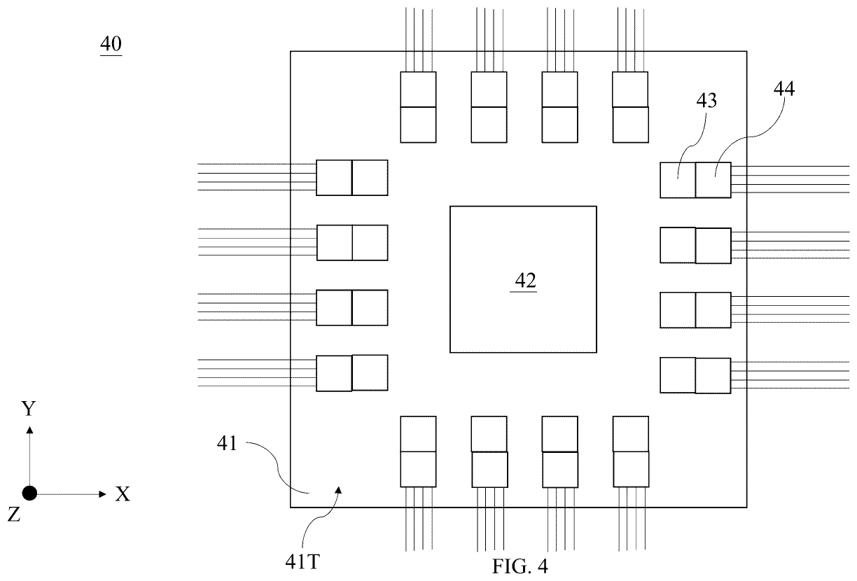

FIG. 4 is a schematic diagram of a CPO 40 from a top view perspective according to some embodiments of the present disclosure. The CPO 40 includes a substrate 41, an EIC 42, a plurality of optical components 43, and a plurality of fiber array units 44. The EIC 42 and the optical components 43 are disposed on the substrate 41, and the EIC 42 is surrounded by the optical components 43. The fiber array units 44 are disposed on the substrate 41 and optically coupled to the optical components 43, respectively. The fiber array units 44 are configured to transmit optical signal from and to the optical components 43. The optical components 43 are electrically connected to the EIC 42 at least via the conductive wiring structure of the substrate 41.

In some embodiments, the substrate 41, the EIC 42, and the optical components 43 of the CPO 40 are similar to those of the CPO 10. In some embodiments, the fiber array unit 44 is similar to the fiber array 30 shown in FIG. 3.

Each of the fiber array units 44 is adhered on a top surface 41T of the substrate 41 by an adhesive (not shown). Specifically, the adhesive is disposed between a bottom surface of the fiber array unit 44 and the top surface 41T of the substrate 41. The adhesive in CPO 40 is similar to the adhesive 22 and the adhesive 35.

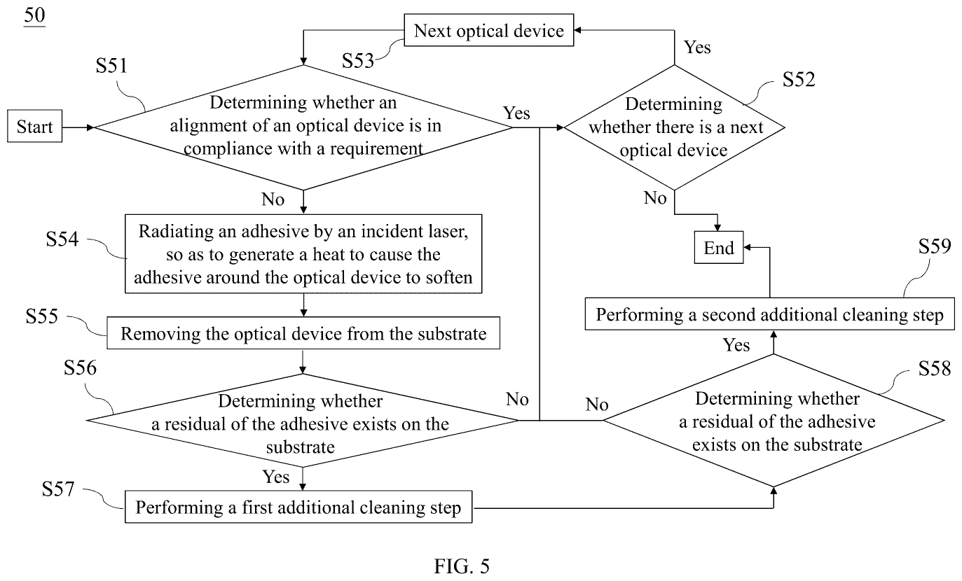

FIG. 5 is a flow chart of a method 50 for cleaning an adhesive from a substrate according to some embodiments of the present disclosure. In some embodiments, the method 50 can be performed to clean the adhesive in the CPO 10, the fiber array unit 30, and the CPO 40. To facilitate explanation, the method 50 uses the reference numerals from FIG. 1 to FIG. 4 for illustration; however, the present disclosure is not limited to these.

The method 50 includes operations S51, S52, S53, S54, S55, S56, S57, S58, and S59. The method 50 starts from the operation S51. In the operation S51, determining whether an alignment of an optical device is in compliance with a requirement is performed. The optical device can be the fiber 14, the fiber array unit 30, or the fiber array unit 44, and the optical device is cured on a substrate by an adhesive. In some embodiments, the substrate can be the substrate 11, the substrate 31, or the substrate 41, and the adhesive can be the adhesive 22, the adhesive 35, or the adhesive on the CPO 40. When the alignment of the optical device is in compliance with the requirement, the method 50 proceeds to the operation S52. In the operation S52, determining whether there is a next optical device is performed. When there is no next optical device, or all of the optical devices are gone through the operation S51, the method 50 ends. When there is still a next optical device, the operation S53 is performed and the operation S51 is performed to the next optical device.

In some embodiments, the requirement may be a minimum level of a transmission efficiency of the electrical signal generated by the EIC or the optical signal in the fiber. In other embodiments, the requirement may be a minimum level of the signal-to noise ratio of the electrical signal or the optical signal.

When the alignment of the optical device is not in compliance with the requirement, the method 50 proceeds to the operation S54. In the operation S54, radiating the adhesive by an incident laser L1 so as to generate a heat to cause the adhesive around the optical device to soften is performed.

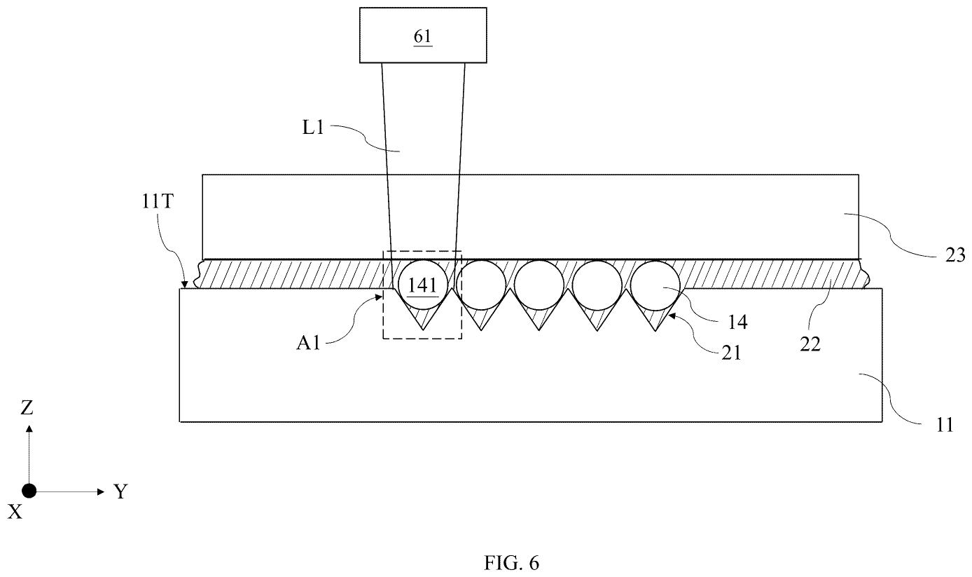

The operation S54 is described alongside FIG. 6. In FIG. 6, an illuminator 61 generates the incident laser L1 toward the adhesive 22. The illuminator 61 is further configured to control a beam size of the incident laser L1 projected on top surface 11T of the substrate 11. The incident laser is projected on a region A1 around the fiber 141 (which is one of the fibers 14, i.e., the optical device stated in the operation S51).

When the incident laser L1 is projected on the adhesive 22, the optical energy of the incident laser L1 is converted to be thermal energy (i.e., heat), and the thermal energy causes the temperature of the adhesive 22 to be raised.

In some embodiments, a diameter of the beam size of the incident laser L1 projected on the top surface 11T is about 60 μm. In some embodiments, a central wavelength of the incident laser L1 is about 1064 nm or 355 nm. In some embodiments, a power of the incident laser L1 is between about 8 W and about 9 W. After the thermal energy is generated, the temperature of the adhesive 22 is raised to above a glass transition temperature of the adhesive 22. As a result, the structure of the adhesive 22 starts to be weakened and soften.

As illustrated in FIG. 6, the glass cap 23 may cover more than one fiber 14. In such embodiment, if the alignment of the fiber 141 is not in compliance with the requirement, the glass cap 23 has to be removed, and the fiber 141 and other fibers 14 originally covered by the glass cap 23 have to be removed. Therefore, the entire adhesive 22 below the glass cap 23 has to be cleaned.

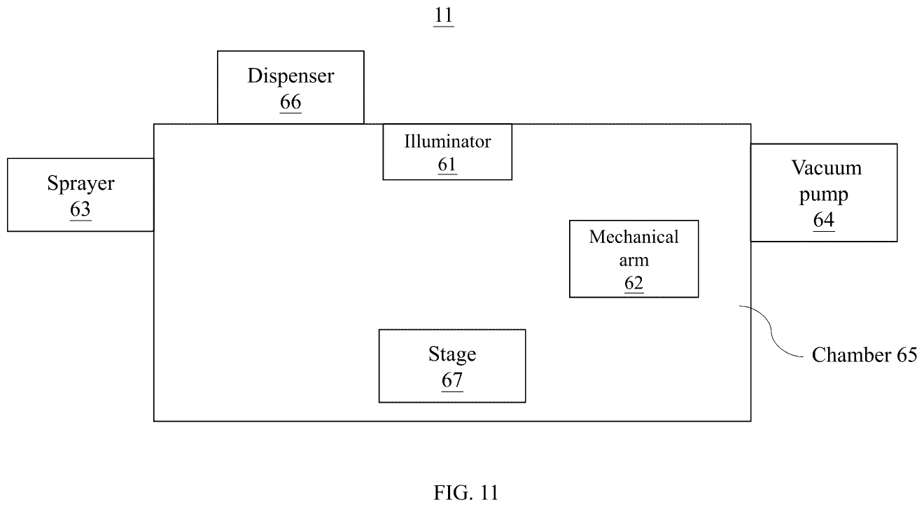

In some embodiments, the illuminator 61 is configured scan the substrate 11 by the incident laser L1. More specifically, the illuminator 61 controls the incident laser L1 to scan the entire adhesive 22 so as to soften the entire adhesive 22. In other embodiments, the scanning is performed by moving the substrate 11, and a stage 67 (shown in FIG. 11) is configured to control the moving the substrate 11.

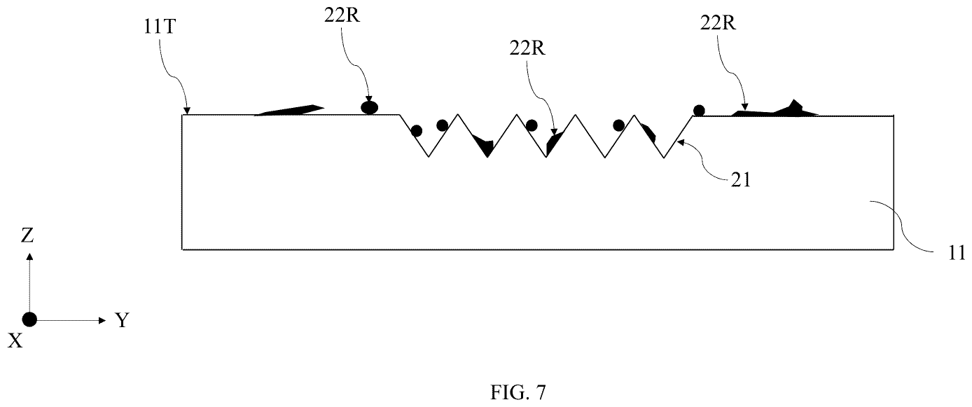

After the adhesive 22 is soften, the operation S55 is performed. In the operation S55, the optical device is removed from the substrate. Please refer to FIG. 7 which is a schematic diagram of performing the operation S55. As shown in FIG. 7, the glass cap 23, the fibers 14, and most of the adhesive 22 are removed. In some embodiments, the glass cap 23 and the fibers 14 are removed by a mechanical arm 62 (shown in FIG. 11), and the adhesive 22 peels off together with the glass cap 32 and the fibers 14 being removed.

In the operation S56, determining whether a residual of the adhesive exists on the substrate is performed. In some embodiments, after the fibers 14 and the glass cap 23 are removed, a portion of the adhesive 22 still stays on the substrate 11. As a result, a residual 22R of the adhesive 22 can be found on the substrate as illustrated in FIG. 7. The residual 22R may exist on the top surface 11T of the substrate 11 and in the v-groove 21. When there is the residual 22R remaining on the substrate 11, the method 50 proceeds to the operation S57. When the substrate 11 is free from having the residual 22R after the operation S55, the method 50 proceeds to the operation S52.

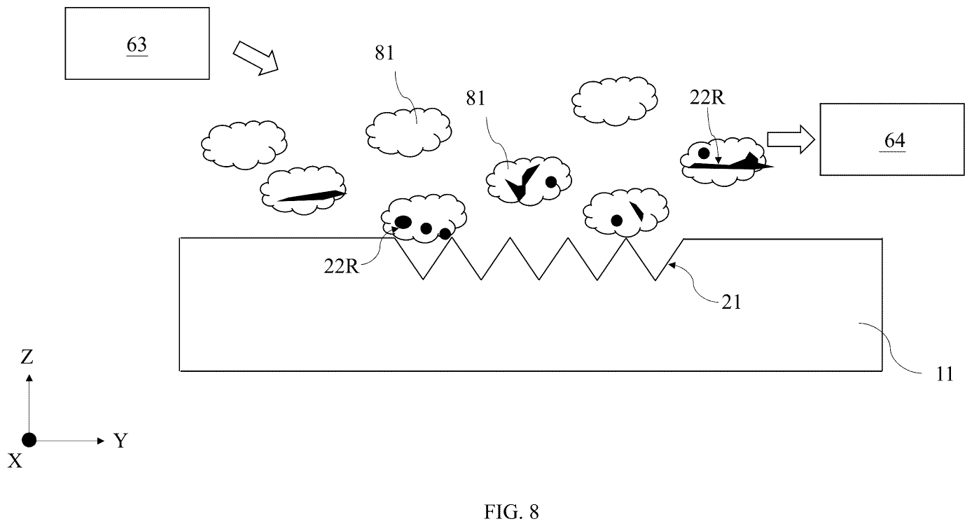

In the operation S57, a first additional cleaning step is performed. The first additional cleaning step is performed to clean the residual 22R. Please refer to FIG. 8 which is a schematic diagram of performing the operation S57 according to some embodiments of the present disclosure. In some embodiments, the first additional cleaning step includes: spraying a low-temperature material 81 onto the substrate 11 to lower a temperature of the residual 22R of the adhesive 22, so as to weaken a bond between the residual 22R and the substrate 11; and extracting, by vacuuming, the low-temperature material 81 with the residual 22R.

In some embodiments, the first additional cleaning step is performed in a chamber 65 (shown in FIG. 11). When the low-temperature material 81 reaches the residual 22R and the substrate 11, the temperatures of the residual 22R and the substrate 11 begin to drop. Because the materials of the residual 22R and the substrate 11 are different, the coefficients of thermal expansion (CTE) of the residual 22R and the substrate 11 are also different. Therefore, when the temperature decreases due to contact with the low-temperature material 81, the change in volume of the residual 22R differs from the change in volume of the substrate 11. As a result, a shear stress is generated at the interface between the residual 22R and the substrate 11, and reduces the bonding strength between the residual 22R and the substrate 11.

After the bonding strength is reduced, the bond between the residual 22R and the substrate 11 is weakened, and the residual 22R appears to leave the substrate 11 and is taken away by the low-temperature material 81.

In some embodiments, the low-temperature material 81 includes liquid nitrogen (LN2), liquid carbon dioxide (LCO2), or solid carbon dioxide (i.e., dry ice).

In some embodiments, a sprayer 63 (shown in FIG. 11) is configured to spray the low-temperature material 81 onto the substrate 11, and a vacuum pump 64 (shown in FIG. 11) is configured to vacuum the chamber 65 to extract the low-temperature material 81 with the residual 22R from the chamber 65.

In the operation S58, after the first additional cleaning step, is performed, determining whether a residual of the adhesive exists on the substrate is performed. In some embodiments, after the first additional cleaning step is performed, there is some residual 22R still stays on the substrate 11. When there is residual 22R still remaining on the substrate 11, the method 50 proceeds to the operation S59. When the substrate 11 is free from having the residual 22R after the operation S57, the method 50 proceeds to the operation S52.

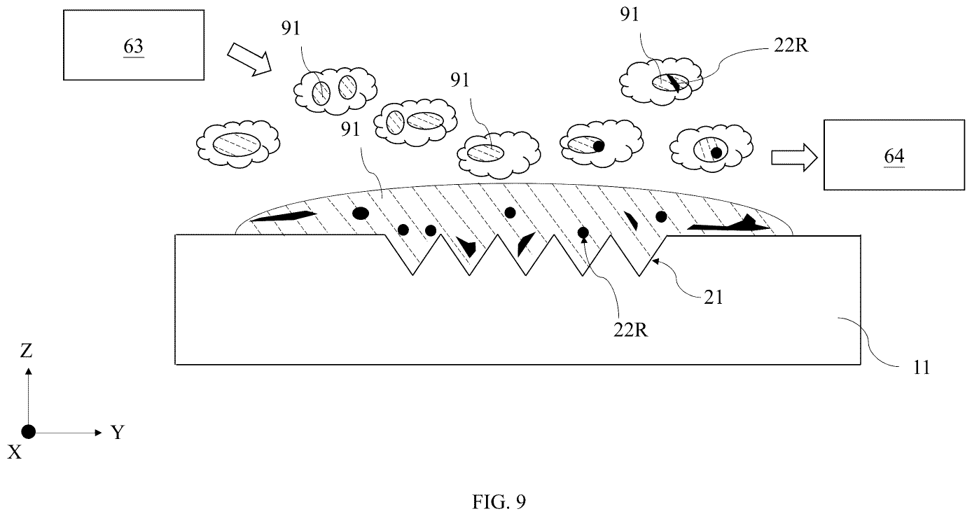

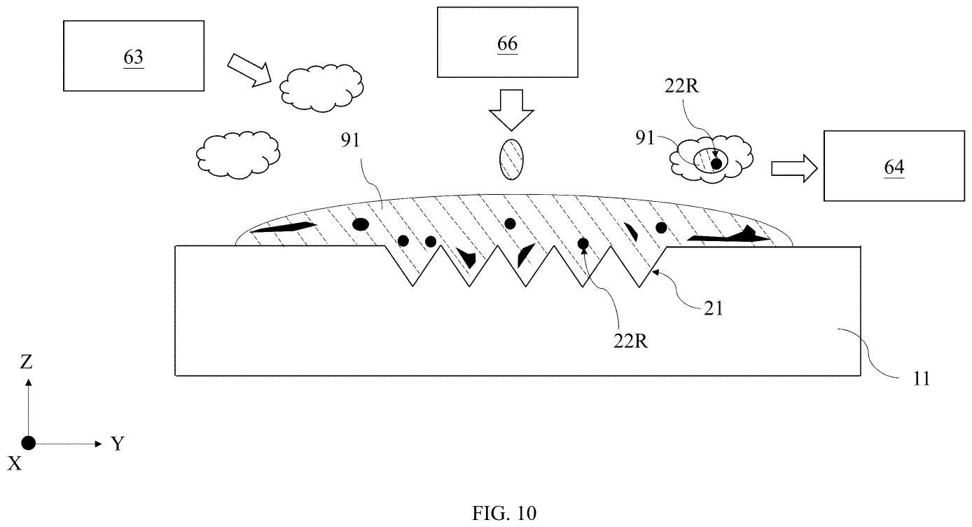

In the operation S59, a second additional cleaning step is performed. The second additional cleaning step is performed to clean the residual 22R. Please refer to FIG. 9 and FIG. 10 which are schematic diagrams of performing the operation S59 according to some embodiments of the present disclosure. In some embodiments, the second additional cleaning step includes: providing a volatile liquid 91 onto the substrate 11 to each the residual 22R of the adhesive 22; and extracting, by vacuuming, the volatile liquid 91 with the residual 22R.

In some embodiments, the second additional cleaning step is performed in the chamber 65. When the volatile liquid 91 reaches the residual 22R and the substrate 11, the small particles of the volatile liquid 91 penetrate into the surface of the residual 22R to etch the residual 22R, so as to weaken the bond between the residual 22R and the substrate 11. In some embodiments, the volatile liquid 91 is free from in contact with the EIC 12 during the operation S59.

After the bond between the residual 22R and the substrate 11 is weakened, the residual 22R appears to leave the substrate 11 and is taken away by the volatile liquid 91 from the chamber 65.

As shown in FIG. 9, in some embodiments, the volatile liquid 91 is mixed with a carrier gas and provided by injecting. In such embodiment, the carrier gas includes nitrogen, and the volatile liquid includes isopropanol or ethanol. The sprayer 63 is further configured to spray the carrier gas with the volatile liquid 91 to the substrate 11 and the residual 22R, and the vacuum pump 64 is configured extract the carrier gas with volatile liquid 91 and the residual 22R from the chamber 65.

As shown in FIG. 10, in some embodiments, the volatile liquid 91 is provided by spraying. In such embodiment, the volatile liquid 91 includes isopropanol or ethanol. A dispenser 66 (shown in FIG. 11) is configured to drop the volatile liquid 91 onto the substrate 11; the sprayer 63 is further configured spray a gas to purge the volatile liquid 91 from the substrate 11; and the vacuum pump 64 is configured vacuum the chamber 65 to extract the gas and the volatile liquid 91 with the residual 22R from the chamber 65.

After the operation S59 is completed, the method 50 ends.

It should be understood that although FIG. 7 to FIG. 10 merely illustrates the embodiments of substrate 11, the present disclosure is not limited thereto. In the embodiments shown in FIG. 7 to FIG. 10, the substrate 11 may also be the substrate 31 and the substrate 41.

In some embodiments, the second additional cleaning step is performed prior to the first additional cleaning step. In other words, the operation S57 and the operation S59 can be switched with each other.

Reference is made to FIG. 11. FIG. 11 is a schematic diagram of a system 11 according to some embodiments of the present disclosure. The system 11 is configured to clean an adhesive in the CPO 10, the fiber array unit 30, and the CPO 40. In some embodiments, the system 11 is configured to perform the method 50.

The system 10 includes the illuminator 61, the mechanical arm 62, the sprayer 63, the vacuum pump 64, the chamber 65, the dispenser 66, and the stage 67. The illuminator 61 is configured to generate the incident laser L1 toward the adhesive so as to raise the temperature of the adhesive. The mechanical arm 62 is configured to move the glass cap 23, the fiber 14, the glass cap 34, the fiber 33, and the fiber array unit 44. The sprayer 63 is configured to provide the low-temperature material 81 during the first additional cleaning step, and provide gas or gas with volatile liquid 91 during the second additional cleaning step. The dispenser 66 is configured to provide the volatile liquid 91 during the second additional cleaning step. The stage 67 is configured to bear and control the motion of the substrate 11, the substrate 31, and/or the substrate 41. The chamber 65 is configured provide an enclosed environment for performing the first additional cleaning step and the second additional cleaning step.

The present disclosure provides a method for cleaning an adhesive from a substrate, in which a fiber is cured in a v-groove of the substrate by the adhesive. The method includes: radiating the adhesive by an incident laser, so as to generate a heat to cause the adhesive to soften; and removing the fiber from the v-groove of the substrate. After the fiber is removed, the v-groove and the substrate is free from having the adhesive.

The present disclosure further provides a method for cleaning an adhesive from a substrate, in which an optical device is cured by the adhesive on the substrate. The method includes: radiating the adhesive by an incident laser, so as to generate a heat to cause the adhesive to soften, wherein a temperature of the adhesive is raised by the heat to above a glass transition temperature of the adhesive; and removing the optical device from the substrate. The adhesive is disposed between a top surface of the substrate and a bottom surface of the optical device. After the optical device is removed, the substrate is free from having the adhesive. The substrate is a substrate of a co-packaged optics (CPO).

The present disclosure further provides a system of cleaning an adhesive from a substrate, in which an optical device is cured by the adhesive on the substrate. The system includes an illuminator and a mechanical arm. The illuminator is configured to generate an incident laser toward the adhesive, and raise a temperature of the adhesive accordingly. After the temperature is raised, by the incident laser, to above a glass transition temperature of the adhesive, the mechanical arm is configured to remove the optical device from the substrate.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, and steps.

What is claimed is:

1. A method for cleaning an adhesive from a substrate, wherein a fiber is cured in a v-groove of the substrate by the adhesive, comprising:
radiating the adhesive by an incident laser, so as to generate a heat to cause the adhesive to soften; and
removing the fiber from the v-groove of the substrate,
wherein after the fiber is removed, the v-groove and the substrate is free from having the adhesive.

2. The method of claim 1, further comprising:
determining whether an alignment of the fiber is in compliance with a requirement,
wherein
when the alignment of the fiber is not in compliance with the requirement, the operation of radiating the adhesive is performed, and
when the alignment of the fiber is in compliance with the requirement, the method further comprises determining whether an alignment of a next fiber is in compliance with the requirement.

3. The method of claim 1, further comprising:
after the fiber is removed, determined whether a residual of the adhesive exists on the substrate; and
when the residual of the adhesive exists on the substrate, performing a first additional cleaning step to remove the residual of the adhesive, comprising:
spraying a low-temperature material onto the substrate to lower a temperature of the residual of the adhesive, so as to weaken a bond between the residual of the adhesive and the substrate, wherein the operation of spraying the low-temperature material is performed in a chamber; and
extracting, by vacuuming, the low-temperature material with the residual of the adhesive from the chamber.

4. The method of claim 3, further comprising:
when the residual of the adhesive exists on the substrate, performing a second additional cleaning step to remove the residual of the adhesive, comprising:
providing a volatile liquid onto the substrate to each the residual of the adhesive, so as to weaken the bond between the residual of the adhesive and the substrate, wherein the operation of providing the volatile liquid is performed in the chamber; and
extracting, by vacuuming, the volatile liquid with the residual of the adhesive from the chamber.

5. The method of claim 4, wherein the volatile liquid is mixed with a carrier gas and provided by injecting, wherein the carrier gas includes nitrogen, and the volatile liquid includes isopropanol or ethanol.

6. The method of claim 4, wherein the volatile liquid is provided by spraying, wherein the volatile liquid includes isopropanol or ethanol.

7. The method of claim 3, wherein the low-temperature material includes liquid nitrogen, liquid carbon dioxide, or solid carbon dioxide.

8. The method of claim 1, wherein the operation of radiating the adhesive by an incident laser comprises:
controlling a beam size of the incident laser projected on the substrate; and
scanning the substrate by the incident laser,
wherein a diameter of the beam size is about 60 μm, a central wavelength of the incident laser is about 1064 nm or 355 nm, and a power of the incident laser is between about 8 W and about 9 W.

9. The method of claim 1, wherein the operation of radiating the adhesive by the incident laser causes that a temperature of the adhesive is raised by the heat to above a glass transition temperature of the adhesive.

10. A method for cleaning an adhesive from a substrate, wherein an optical device is cured by the adhesive on the substrate, comprising:
radiating the adhesive by an incident laser, so as to generate a heat to cause the adhesive to soften, wherein a temperature of the adhesive is raised by the heat to above a glass transition temperature of the adhesive; and
removing the optical device from the substrate,
wherein the adhesive is disposed between a top surface of the substrate and a bottom surface of the optical device,
wherein after the optical device is removed, the substrate is free from having the adhesive,
wherein the substrate is a substrate of a co-packaged optics (CPO).

11. The method of claim 10, further comprising:
after the optical device is removed, determined whether a residual of the adhesive exists on the top surface of the substrate; and
when the residual of the adhesive exists on the top surface of the substrate, performing a first additional cleaning step to remove the residual of the adhesive, comprising:
spraying a low-temperature material onto the top surface of the substrate to lower a temperature of the residual of the adhesive, so as to weaken a bond between the residual of the adhesive and the top surface of the substrate, wherein the operation of spraying the low-temperature material is performed in a chamber; and
extracting, by vacuuming, the low-temperature material with the residual of the adhesive from the chamber.

12. The method of claim 11, further comprising:
when the residual of the adhesive exists on the top surface of the substrate, performing a second additional cleaning step to remove the residual of the adhesive, comprising:
providing a volatile liquid onto the top surface of the substrate to each the residual of the adhesive, so as to weaken the bond between the residual of the adhesive and the substrate, wherein the operation of providing the volatile liquid is performed in the chamber; and
extracting, by vacuuming, the volatile liquid with the residual of the adhesive from the chamber.

13. The method of claim 11, wherein the operation of performing the second additional cleaning step is performed after the operation of performing the first additional cleaning step.

14. The method of claim 11, wherein the operation of performing the first additional cleaning step is performed after the operation of performing the second additional cleaning step.

15. The method of claim 10, wherein a central wavelength of the incident laser is about 1064 nm or 355 nm, and a power of the incident laser is between about 8 W and about 9 W.

16. The method of claim 10, wherein the operation of radiating the adhesive by the incident laser comprises:
controlling a beam size of the incident laser projected on the top surface of the substrate; and
scanning the top surface of the substrate by the incident laser.

17. The method of claim 16, wherein a diameter of the beam size is about 60 μm.

18. A system of cleaning an adhesive from a substrate, wherein an optical device is cured by the adhesive on the substrate, comprises:
an illuminator, configured to generate an incident laser toward the adhesive, and raise a temperature of the adhesive accordingly; and
a mechanical arm,
wherein after the temperature is raised, by the incident laser, to above a glass transition temperature of the adhesive, the mechanical arm is configured to remove the optical device from the substrate.

19. The system of claim 18, further comprising:
a sprayer, configured to spray a low-temperature material onto the substrate to lower a temperature of a residual of the adhesive, so as to weaken a bond between the residual of the adhesive and the substrate; and
a vacuum pump, configured to extract the low-temperature material with the residual of the adhesive.

20. The system of claim 18, further comprising:
a dispenser, configured to provide a volatile liquid onto the substrate to each a residual of the adhesive, so as to weaken a bond between the residual of the adhesive and the substrate; and
an vacuum pump, configured to extract the volatile liquid with the residual of the adhesive.
